(19) United States
(12) Patent Application Publication
(10) Pub. No.: US 2010/0263738 A1
(43) Pub. Date: Oct. 21, 2010

(54) Pressure Equalization Assembly for a Liquid Storage Vessel

(75) Inventor: Julian S. Taylor, Oklahoma City, OK (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: Taylor Innovations, L.L.C., Oklahoma City, OK (US)

(21) Appl. No.: 12/489,886

(22) Filed: Jun. 23, 2009

Related U.S. Application Data
(60) Provisional application No. 61/170,442, filed on Apr. 17, 2009.

(51) Int. Cl. F16K 17/19; G05D 16/14

(52) U.S. Cl. 137/209; 137/513; 137/535

(57) ABSTRACT

A vapor pressure equalization assembly having an underpressure relief assembly and an overpressure relief assembly in fluidic communication with the vapor space of a liquid storage tank (vessel). The underpressure and overpressure relief assemblies each have movable pistons sealingly engageable with respective sealing members, and biasing members which exert respective biasing forces to maintain the pistons in sealing engagement with the sealing members. A predetermined underpressure or overpressure differential between the vapor space pressure and atmospheric pressure will cause one of the pistons to open fluidic communication of the vapor space to equalize the vapor space pressure with that of the surrounding atmospheric pressure.

### RELATED APPLICATION

This application makes a claim of domestic priority under 35 U.S.C. §119(e) to U.S. Provisional Patent Application No. 61/170,442 filed Apr. 17, 2009.

### BACKGROUND

It is common to collect liquids in storage vessels (tanks). Such liquids can include oil and other hydrocarbon based fluids, water (fresh or brine), hazardous chemicals, and the like. Liquid storage vessels can be buried underground such as underground fuel storage tanks used in automotive service stations, or located above ground such as storage tanks used in association with drilling and refining operations in the oil and gas industry, or the storage of drinking water in municipal water supply systems. Some vessels can be relatively large and can accommodate thousands, or even millions, of gallons of liquid.

Vessels can be closed or open systems. A closed vessel may be used to store various types of pressurized fluids such as liquefied natural gas or other volatile substances. Closed vessels may be specifically sealed off from the surrounding atmosphere to maintain the contents under pressure and hence, in a liquefied form.

Open vessels on the other hand may be provided with screened vents or other mechanisms to allow equalization of the vapor space pressure within the vessel with that of the surrounding atmosphere. For example, it may be desirable to admit atmospheric air to enter the vapor space of the vessel as liquid is pumped (or gravity fed) out of the vessel, and it may be desirable to release pressure from the vapor space of the vessel as additional liquid is pumped or otherwise added to the contents of the vessel.

Atmospheric effects may also alter the interior pressure of a storage vessel with respect to the pressure of the surrounding atmosphere. For example, during the course of a hot summer day solar heating of the exterior of the storage vessel may result in a substantial increase in the internal pressure of the vessel as compared to the ambient atmospheric pressure.

Failure to maintain the interior vapor space of a storage vessel within some range of the pressure of the surrounding atmosphere may lead to a number of problems, such as reduced fluidic flow as efforts are made to transfer liquid to or from the vessel. In some extreme cases, a significant pressure differential may even result in structural damage to a vessel.

At the same time, there are a number of reasons why it may not be desirable to maintain a continuous venting of the vapor space of a liquid storage vessel with the surrounding atmosphere. For example, a continuously open vent, even if the vent is screened, can still admit debris or other substances from the external environment, thereby introducing undesirable contaminants to the stored liquid.

Similarly, evaporated vapors or fumes from the stored liquid, such as water vapor or volatile hydrocarbons, may pass through a continuously open vent to the surrounding atmosphere at an unacceptable rate. This can lead to an undesired loss of product or, in some cases, unacceptable levels of environmental contamination.

### SUMMARY

Various embodiments of the present invention are generally directed to a vapor pressure equalization assembly for use in abating overpressure and underpressure conditions in a vapor space of a liquid storage tank.

In accordance with some embodiments, a vapor pressure equalization assembly is provided with an underpressure relief assembly and an overpressure relief assembly. These respective assemblies are placed in fluidic communication with the vapor space of a storage tank containing a liquid, and each includes a movable piston sealingly engageable with sealing member.

Respective biasing members, such as coiled springs, exert biasing forces to keep the respective pistons in a normally sealed engagement with the associated sealing members. When a predetermined underpressure differential or overpressure differential between the pressure of the vapor space and that of the surrounding atmosphere arises, the associated piston will move to an open position to allow fluidic communication between the vapor space and the surrounding atmosphere, thereby equalizing the vapor space pressure.

Other features and advantages of the various embodiments of the present invention will become apparent when the following detailed description is read in conjunction with the drawings and appended claims.

### BRIEF DESCRIPTION OF THE DRAWINGS

FIG. 1 shows an exemplary liquid storage tank having a vapor pressure equalization assembly constructed and operated in accordance with various embodiments of the present invention.

FIG. 2 is an isometric representation of the vapor pressure equalization assembly of FIG. 1.

FIG. 3 is a cross-sectional view of the vapor pressure equalization assembly of FIGS. 1-2.

FIG. 4 shows an alternative construction for the equalization assembly of FIG. 1 in accordance with further embodiments of the present invention.

FIG. 5 is a cross-sectional representation of the alternative vapor pressure equalization assembly of FIG. 4.

FIG. 6 shows another alternative configuration for a manifold that utilizes a gauge plug connection.

FIG. 7 is a functional block diagram to illustrate a field calibration of the equalization assembly of FIG. 1 in accordance with some embodiments.

### DETAILED DISCUSSION

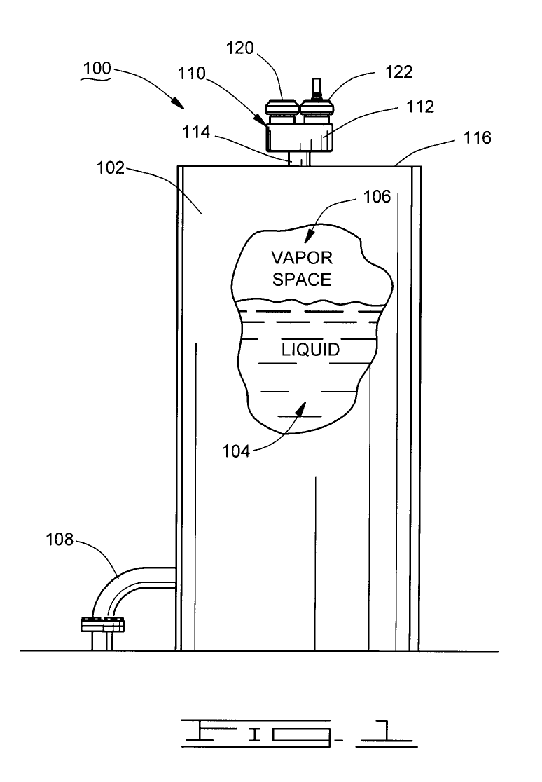

FIG. 1 shows a liquid storage system 100 constructed in accordance with various embodiments of the present invention. The system includes an exemplary liquid storage vessel 102 adapted to store a liquid 104. A vapor space above the liquid 104 is identified at 106. Due to the normally sealed nature of the storage tank 102, evaporated vapors from the liquid 104 will tend to accumulate within the vapor space 106.

For purposes of providing a concrete example, the liquid 104 is contemplated as comprising a non-pressurized hydrocarbon liquid, such as crude oil or similar. Other forms of liquid can readily be used, however.

As will be appreciated, a number of factors may result in changes in the pressure of the vapor space 106 over time. Environmental cycling, such as thermal heating and cooling effects, may result in significant changes in the internal pressure of the vapor space 106 within the tank 102. The pressure of the vapor space 106 may also change due to changes in the amount of liquid 104 within the tank; the pressure of the vapor space 106 will generally tend to rise as additional liquid is introduced into the tank, and the pressure will generally fall as liquid is removed from the tank. Such fluidic transfers can take place via a transfer conduit 108.

Accordingly, a vapor pressure equalization assembly is provided at 110. As described below, the vapor pressure equalization assembly 110 (hereinafter “assembly”) normally operates in a closed mode to seal the vapor space 106 from the surrounding environment. This normally prevents harmful environmental pollutants from passing out of the tank from the vapor space 106 and into the surrounding environment.

When the pressure of the vapor space 106 falls outside a predetermined threshold range, however, the assembly 110 transitions to an open mode to facilitate fluidic transfer between the vapor space and the surrounding atmosphere.

The threshold range is bounded by an upper threshold differential value and a lower threshold differential value. When the vapor space pressure exceeds the upper threshold value, the assembly 110 opens to facilitate a transfer of vapors from the vapor space 106 to the surrounding environment. Once the vapor space pressure is reduced to within the upper threshold value, the assembly 110 transitions back to the normally closed mode.

Similarly, when the vapor space pressure falls below the lower threshold value, the assembly 110 opens to facilitate a transfer of atmospheric air from the surrounding environment into the vapor space 106, after which the assembly 110 transitions back to the normally closed mode.

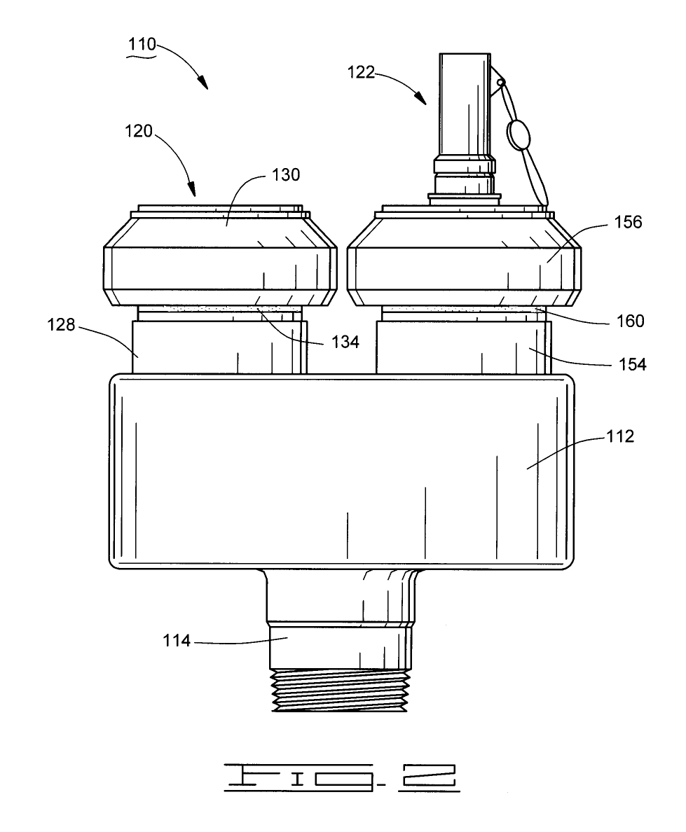

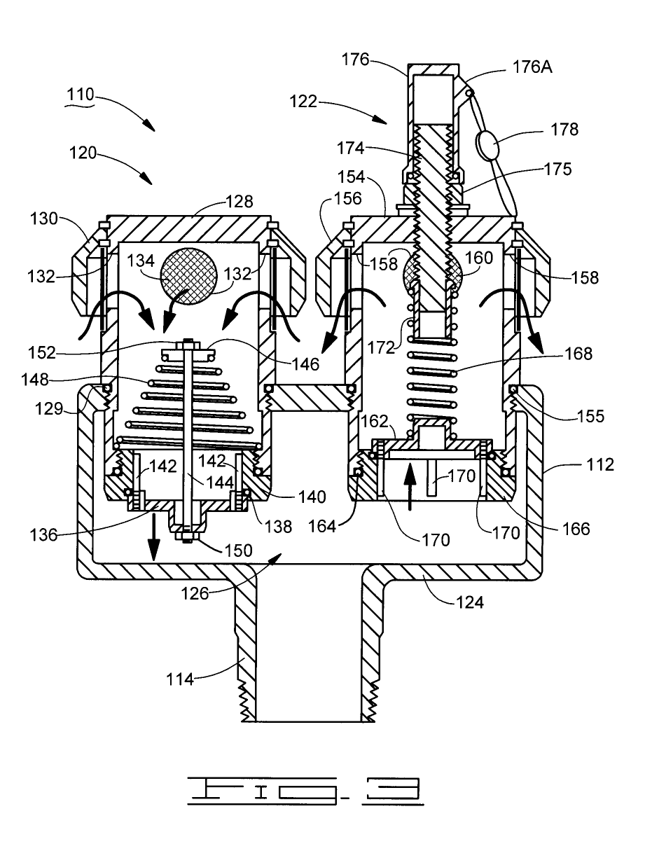

FIG. 2 shows an isometric representation of the assembly 110 of FIG. 1. FIG. 3 provides a corresponding cross-sectional representation of the assembly. As shown in FIGS. 2-3, the vapor pressure equalization assembly 110 includes an elongated manifold 112 that has a threaded coupling 114 adapted for connection to a corresponding threaded bore (not shown) in the vessel 102.

While the vapor pressure equalization assembly 110 is shown mounted on a top surface 116 of the storage vessel 102 (see FIG. 1), such is not necessarily required as any suitable mounting location can be used, so long as the vapor pressure equalization assembly 110 is maintained in fluidic communication with the vapor space 106 above the liquid level 104.

The vapor pressure equalization assembly 110 includes an underpressure (vacuum) relief assembly 120 and an overpressure relief assembly 122. These assemblies 120, 122 are respectively mounted via threaded bores in a housing 124 of the manifold 112 and extend into an interior manifold chamber 126.

The underpressure relief assembly 120 includes a substantially cylindrical relief assembly body 128 which sealingly engages the housing 124 via annular sealing member 129. A vent cap flange (weather guard) 130 is affixed to an upper end of the assembly body 128. A number of spaced apart vent apertures 132 are spatially arranged about the relief assembly body 128, as shown. An annular screen 134 of a durable fine wire mesh or the like is supported to surround the relief assembly body 128 and cover the apertures 132. The covering flange 130 and a lower extent of the screen 134 are shown in FIG. 2.

A piston 136 normally seals the vapor space 106 from the surrounding atmosphere by engaging an annular sealing member 138. The sealing member 138 is characterized as an elastomeric o-ring, although other sealing configurations can be used as desired. The sealing member 138 is supported by a threaded insert member 140 which engages the body 128 as shown. A number of guide legs 142, in this case four (4), extend upwardly from the piston 136 to maintain the piston 136 in a centered relation with an annular interior wall surface of the insert member 140.

A piston shaft, or rod 144 extends upwardly from the piston 136 and terminates at an annular flange support 146. The flange support 146 is characterized as a thick washer but can take other forms as desired. A biasing member 148, characterized as a coiled tapered spring, is compressed between the insert member 140 and the flange support 146 to provide an upwardly directed force upon the piston 136. It is contemplated that the force supplied by the spring 148 will be relatively small. Generally, in some embodiments the spring 148 is sized to overcome the weight of the piston 136, shaft 144 and support flange 146, since gravity will tend to urge these members downwardly away from the sealing member 138.

The interior fluidic pressure of the vapor space 106 will also apply an upwardly directed force upon the piston 136. The amount of this upwardly directed force will be determined in relation to the pressure of the vapor space 106 and the areal extent of the downwardly facing surface of the piston 136. This upwardly directed force will be countered by a downwardly directed force by the atmospheric pressure of the surrounding atmosphere upon the areal extent of the upwardly facing surface of the piston 136.

So long as the interior pressure of the vapor space 106 is substantially that of the surrounding atmosphere, the piston 136 will be retained via the biasing of the spring 148 in sealing engagement with the sealing member 138. However, once the pressure of the vapor space 106 is sufficiently reduced with respect to the pressure of the surrounding atmosphere, the piston 136 will become unseated from the sealing member 138 and will begin to move downwardly.

As the piston 136 is drawn downwardly, the spring 148 will be compressed, and atmospheric air will pass through the respective screen 134 and vent apertures 132, past the piston 136 (between adjacent legs 142) and into the interior chamber 126 of the manifold. This will continue until the pressure within the interior chamber 126 (and hence, the vapor space 106) is raised to a sufficient level that the combined upwardly directed bias force from the vapor space pressure and the spring 148 will once again close the piston 136.

The vacuum relief assembly 120 thus automatically operates in response to the pressure differential between the vapor space pressure and the surrounding atmospheric pressure. The setpoint at which the vacuum relief assembly 120 opens (i.e., the threshold pressure differential) can be adjusted in a number of ways such as by adjusting the compression force of the spring 148 via nuts 150, 152.

The pressure relief assembly 122 operates in a similar fashion to automatically rectify overpressure conditions, and utilizes many of the same components incorporated into the vacuum relief assembly 120. As denoted in FIG. 3, the pressure relief assembly 122 includes a cylindrical body 154 which sealingly engages the housing 124 via an annular sealing member 155. The body 154 supports an annular cap flange (weather guard) 156 and includes vent apertures 158 covered by a surrounding screen 160.

A normally closed piston 162 abuts a sealing member (o-ring) 164 supported by an insert member 166. A biasing member 168, in this case a second coiled spring, applies a downwardly directed biasing force upon the piston 162 to maintain the piston in the normally closed position.

The internal pressure of the vapor space 106 applies an upwardly directed force upon the piston 162 in relation to the areal extent of the exposed lower surface of the piston, and the exterior atmospheric pressure applies a downwardly directed force upon the piston 162 in relation to the areal extent of the exposed upper surface of the piston.

When the interior pressure within the chamber 126 exceeds the external atmospheric pressure sufficiently to overcome the biasing force of the spring 168, the piston 162 will move upwardly off of the sealing member 164, facilitating a flow of gasses from the vapor space 106 to flow past the piston 162, through the apertures 158 and through the screen 160 to the exterior atmosphere. A number of legs 170 extend from the piston 162 to maintain the piston in a desired centered relation during such movement, and the escaped vapors will pass between these legs as before.

When a sufficient volume of gasses from the vapor space have been vented to reduce the vapor space/exterior pressure differential to a resulting force that is less than the biasing force of the spring 168, the piston 162 will be automatically reseated on the sealing member 164, thereby closing the pressure relief assembly 122.

The spring 168 is compressed between the piston 162 and an annular support 172. The support 172 is coupled to a distal end of a threaded shaft 174, which extends through the body 154. A threaded nut 175 operates as a jam nut to set the depth of the threaded shaft 174 within the body 154, and hence, the compression force of the spring 168.

To adjust the force of the spring 168, a user removes a protective cover 176 and rotates the nut 175 to threadingly advance or retract the threaded shaft 174 to the desired depth. Although not shown, a flat surface can be provided at the proximal end of the shaft 174 to secure the shaft during such operations. The cover 176 is then replaced onto the proximal end of the shaft 174, and a wire tie-off tag 178 can be used to secure an ear 176A of the cover 176 to discourage further adjustment and to provide indication of tampering.

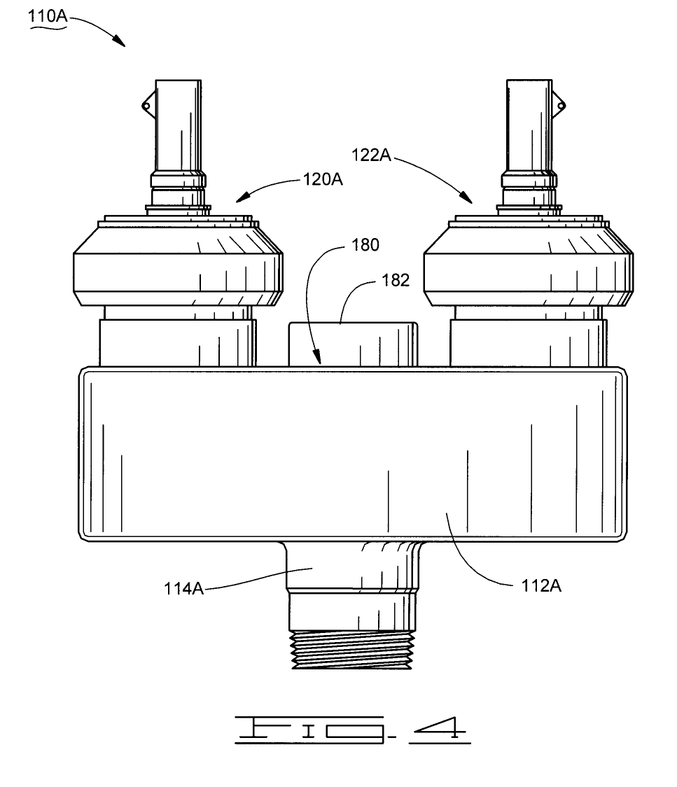

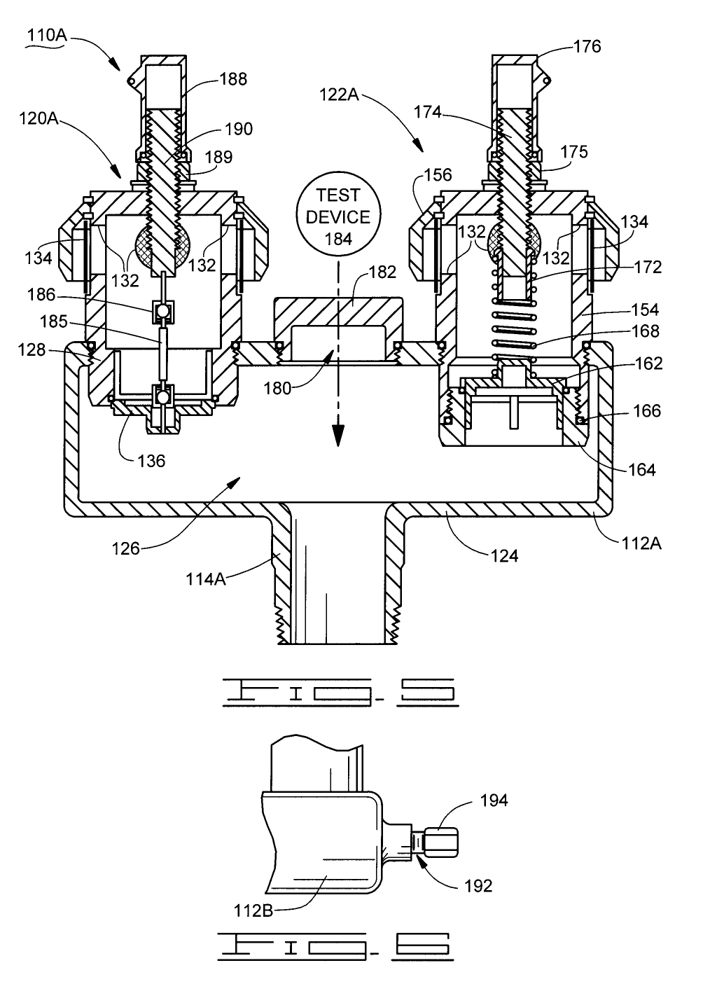

An alternative embodiment for the vapor pressure equalization assembly is denoted at 110A in FIGS. 4-5. The alternative embodiment of FIGS. 4-5 is generally similar in construction and operation to that of the vapor pressure equalization assembly 110 of FIGS. 2-3, and the same reference numbers in the drawings will be used where the components are identical to that described herein above. As shown, the vapor pressure equalization assembly 110 includes a manifold 112A, a coupling 114A, an underpressure relief assembly 120A and an overpressure relief assembly 122A.

An intermediary access port 180, in fluidic communication with the manifold chamber 126 and axially aligned with the coupling 114, is disposed on the manifold 112A between the respective assemblies 120A, 122A. A removable threaded cover 182 normally closes the access port 180. The access port provides access for a test device 184 (see FIG. 5) to be admitted into the storage vessel 102 to take a liquid sample, measure a liquid level, or perform some other testing operation upon the liquid 104 in the storage vessel 102.

In some embodiments, the underpressure and pressure relief assemblies 120A, 122A in FIG. 4 can take the same configuration as set forth in FIG. 3; that is, the respective assemblies 120, 122 in FIG. 3 can be used with the larger manifold 112A of FIG. 4 having the intermediary access port and cover 180, 182.

Alternatively, the underpressure relief assembly 120A of FIG. 4 can be constructed with the internal configuration as that shown in FIG. 5. In FIG. 5, a biasing extension spring 185 is connected to the piston 136 to bias the piston 136 in the manner described above for the vapor pressure equalization assembly 110. The biasing extension spring 185 comprises a small diameter, symmetric coiled spring attached to a universal ball joint 186, which in turn is coupled to a threaded shaft 188.

As before, the depth of the shaft 188, and hence the setpoint for the piston 136, can be adjusted by advancing the threaded shaft 188 relative to jam nut 189, and a protective cover 190 can be installed as before.

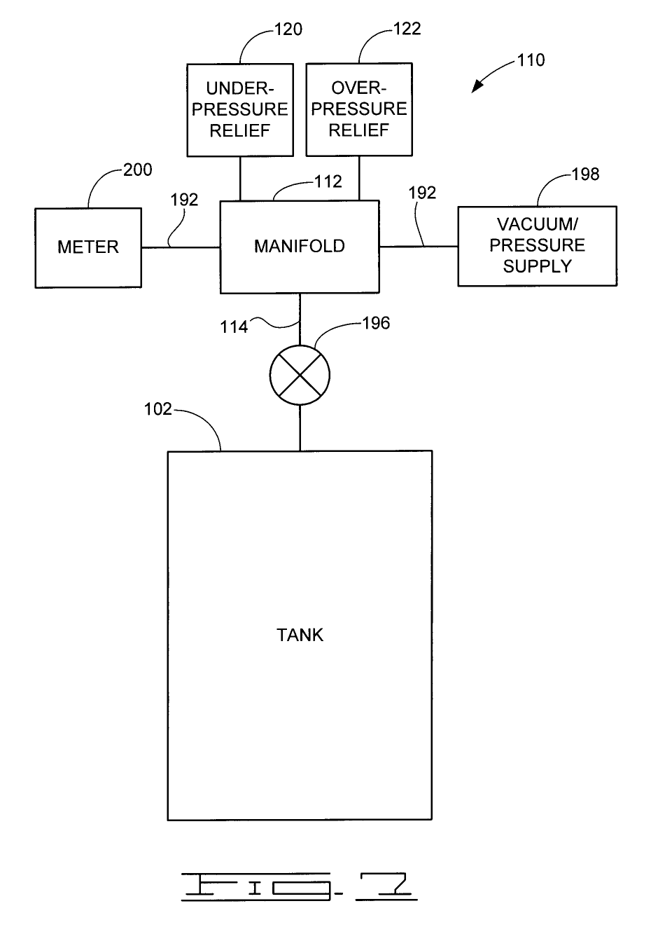

FIG. 6 shows another embodiment for the equalization assemblies 110, 110A discussed above. In FIG. 6, a manifold 112B includes a port 192 with a threaded sealing cap 194. The port 192 facilitates connection of a gauge plug or other suitable instrumentation device. For example, a gauge plug can be inserted through the port 190 for the purpose of taking various readings of operational or environmental conditions, such as internal and external operational pressures and/or temperatures. Various other types and locations of ports could be incorporated as required.

Unlike many prior art equalization systems which fail to hold a setpoint pressure differential, the various embodiments disclosed herein maintain the storage tank in a continuously sealed (closed) condition until and only at such time that the pressure within the vapor space exceeds the upper threshold level or falls below the lower threshold level, after which the system returns to maintain a sealed condition. The pressure in the vapor space will thus not necessarily equal that of the surrounding atmosphere, but will be within the predetermined range of acceptable pressure differentials.

It follows that, depending on the structural integrity of a storage tank, the tank may be able to remain fully sealed against the external environment over a wide range of environmental cycling conditions. For example, a given tank may heat up during a hot day and cool off during the following night, and if the pressure excursions can be safely handled by the tank, no venting to the external atmosphere will take place. This advantageously prevents environmental contamination by eliminating the unnecessary venting of volatile fumes to the surrounding atmosphere, and may prevent the tank owner from incurring fines or other sanctions from a regulatory authority carrying out on-site “sniffer” type inspections in an attempt to detect emitted vapors.

In some embodiments, the respective upper and lower thresholds are set in relation to the structural capabilities of the tank so that, should changes in internal pressure be sufficient to approach those that may result in damage, the system will safely vent (or admit) fluid to prevent such damage, but otherwise prevent such venting or admitting of fluid in all other cases. Exemplary structural capabilities of some types of storage tanks may be on the order of about +6.0 ounces per square inch (6.0 oz/in2) of positive pressure and about −0.4 oz/in2 of negative pressure. The setpoint pressure differential thresholds can be set at some derated percentage, such as 80% of these values.

On-site field calibration operations can also be made as desired. FIG. 7 provides a functional block diagram of the storage tank 102 of FIG. 1 and the equalization assembly 110 of FIGS. 2-3. The manifold 112, underpressure relief 120 and overpressure relief 122 components of the assembly 110 are depicted separately. A user operated manual valve 196, such as a ball valve, is coupled between the coupling 114 and the tank to allow the interior of the manifold to be temporarily isolated from the vapor space of the tank 102.

During an on-site calibration of the system, the user can close the valve 196 and vent the contents of the manifold to the surrounding atmosphere. A pressure/vacuum supply apparatus 198, such as a portable tank, compressor, vacuum pump, etc. can be coupled to the manifold 112 via a first port 192 (see FIG. 6). A pressure meter 200 with a GUI display (numeric pressure value readout, etc.) can be coupled to the manifold 112 via a second port 192.

The user can utilize the apparatus 198 to set the manifold pressure to a first desired level, such as a first vacuum (negative) pressure, and adjust the underpressure relief assembly 120 until the assembly 120 operates to open at this desired level. The holding pressure of the assembly 120 can then be determined via the meter 200. For example, the assembly 120 may be set to operate to nominally open at −0.4 oz/in² and thereafter close and hold −0.3 oz/in² of vacuum pressure.

The foregoing steps can then be repeated by supplying a positive pressure to the manifold 112 and adjusting the overpressure relief assembly 122 until the assembly 122 opens at this second desired level. The holding pressure of the assembly 122 can then be determined via the meter 200. For example, the assembly 122 may operate to open at +6.0 oz/in² and thereafter close and hold +5.9 oz/in² of positive pressure. In this example, the operational pressure differential range would thus be from −0.4 to +6.0 oz/in²; pressures at or beyond this range would result in the opening of the equalization assembly 110, and the equalization assembly would remain closed for pressure excursions that remained within this range.

It will be appreciated that the various embodiments discussed herein provide a number of advantages over the prior art. The various embodiments provide both overpressure and underpressure relief at specified levels, while normally closing the vapor space of the storage vessel to the surrounding atmosphere at all other times. The assembly is readily constructed and maintained, and is contemplated to provide reliable operation over a variety of changing environmental conditions.

While the various embodiments utilize both underpressure and overpressure vapor pressure equalization, it will be appreciated that a single assembly can be alternatively provided; for example, an equalization assembly can be supplied with just overpressure relief capabilities without the associated underpressure relief capabilities, or vice versa. Similarly, multiple ports with different setpoints can be provided to facilitate greater rates of fluidic exchange between the vapor space and surrounding atmosphere under different environmental and/or operational conditions.

It will be clear that the various embodiments presented herein are well adapted to carry out the objects and attain the ends and advantages mentioned as well as those inherent therein. While presently preferred embodiments have been described for purposes of this disclosure, numerous changes may be made that will readily suggest themselves to those skilled in the art and that are encompassed in the spirit of the invention disclosed and as defined in the appended claims.

What is claimed is:

1. A vapor pressure equalization assembly for equalizing a pressure of a vapor space of a liquid storage tank relative to a pressure of an external atmosphere, comprising:
an underpressure relief assembly in fluidic communication with the vapor space and comprising a movable first piston, a first sealing member engageable by the first piston and a first biasing member for biasing the first piston in sealing engagement with the first sealing member; and
an overpressure relief assembly in fluidic communication with the vapor space and comprising a movable second piston, a second sealing member engageable by the second piston, and a second biasing member for biasing the second piston in sealing engagement with the second sealing member;
wherein a predetermined pressure differential between the pressure of the vapor space pressure and surrounding atmospheric pressure moves one of the first and second pistons to disengage the respective one of the first and second sealing members to open fluidic communication between the vapor space and the external atmosphere.

2. The vapor pressure equalization assembly of claim 1, wherein the pressure differential is characterized as a pressure differential below a selected low threshold pressure, and wherein after sufficient vapor flow has occurred while the first piston is disengaged from the first sealing member the vapor space pressure is returned to no lower than the low threshold pressure, permitting the first biasing member to return the first piston into sealing engagement with the first sealing member.

3. The vapor pressure equalization assembly of claim 2, wherein the pressure differential is characterized as a pressure differential beyond a selected high threshold pressure, and wherein after sufficient vapor flow has occurred while the second piston is disengaged from the second sealing member the vapor space pressure is returned to no higher than the high threshold pressure, permitting the second biasing member to return the second piston into sealing engagement with the second sealing member.

4. The vapor pressure equalization assembly of claim 1, wherein the first biasing member comprises:
a spring member wherein a first end of the spring member is connected to the first piston;
a spring compression shaft connected to an opposing second end of the spring member so that the spring member is compressed between the spring compression shaft and the first piston; and
means for moving the spring compression shaft in a selected one of toward the first piston and away from the first piston thereby adjusting a compression force of the spring member.

5. The vapor pressure equalization assembly of claim 4 wherein the means for moving the spring compression shaft relative to the first piston comprises a rotator member that is threadingly engaged with the spring compression shaft whereby rotation of the rotator member in a first rotational direction advances the spring compression shaft toward the first piston and rotation of the rotator member in a second rotational direction advances the spring compression shaft away from the first piston.

6. The vapor pressure equalization assembly of claim 1, wherein the second biasing member comprises:
a spring member wherein a first end of the spring member is connected to the second piston;
a spring compression shaft connected to an opposing second end of the spring member so that the spring member is compressed between the spring compression shaft and the second piston; and
means for moving the spring compression shaft in a selected one of toward the second piston and away from the second piston thereby adjusting a compression force of the spring member.

7. The vapor pressure equalization assembly of claim 6, wherein the means for moving the spring compression shaft relative to the second piston comprises a rotator member that is threadingly engaged with the spring compression shaft whereby rotation of the rotator member in a first rotational direction advances the spring compression shaft toward the second piston and rotation of the rotator member in a second rotational direction advances the spring compression shaft away from the second piston.

8. The vapor pressure equalization assembly of claim 1 further comprising a manifold with an interior chamber in fluidic communication with the vapor space, the manifold comprising a housing surface which supports the respective underpressure and overpressure relief assemblies in fluidic communication with the interior chamber of said manifold.

9. The vapor pressure equalization assembly of claim 8, further comprising a port coupled to the manifold with a sealing cap, the port facilitating connecting a test device in fluidic communication with the interior chamber of the manifold.

10. The vapor pressure equalization assembly of claim 1, wherein the underpressure relief assembly establishes fluidic communication between the vapor space and the external atmosphere when a pressure of the vapor space falls below a first lower pressure threshold level, wherein the overpressure relief assembly establishes fluidic communication between the vapor space and the external atmosphere when a pressure of the vapor space rises above a second higher pressure threshold level, and wherein the respective underpressure and overpressure relief assemblies remain in a closed mode to prevent fluidic communication between the vapor space and the external atmosphere when a pressure of the vapor space remains between the first lower and second higher pressure threshold levels.

11. An apparatus comprising:
a manifold configured to be fluidicly coupled to a vapor space of a liquid storage vessel;
a first pressure equalization assembly coupled to the manifold, the first pressure equalization assembly comprising a normally closed moveable first piston, a first sealing member, and a first biasing member which applies a biasing force upon the first piston to retain the first piston in contacting engagement with the first sealing member, wherein an underpressure differential between a pressure of the vapor space and a pressure of a surrounding atmosphere external to the storage vessel overcomes the biasing force and moves the piston away from the sealing member to facilitate fluidic transfer between the vapor space and the surrounding atmosphere; and
a second pressure equalization assembly coupled to the manifold, the second pressure equalization assembly comprising a normally closed moveable second piston, a second sealing member, and a second biasing member which applies a biasing force upon the second piston to retain the second piston in contacting engagement with the second sealing member, wherein an overpressure differential between a pressure of the vapor space and a pressure of a surrounding atmosphere external to the storage vessel overcomes the biasing force and moves the second piston away from the sealing member to facilitate fluidic transfer between the vapor space and the surrounding atmosphere.

12. The apparatus of claim 11, wherein the underpressure differential is characterized as a first pressure differential to a selected threshold, wherein the first pressure differential is changed after sufficient fluidic flow has occurred while the first piston is moved away from the first sealing member with the differential pressure being within said selected threshold, and wherein the biasing member returns the first piston into contacting engagement with the first sealing member.

13. The apparatus of claim 12, wherein the overpressure differential is characterized as a second pressure differential to a selected threshold, wherein the second pressure differential is changed after sufficient fluidic flow has occurred while the second piston is moved away from the second sealing member with the differential pressure being within said selected threshold, and wherein the second biasing member returns the second piston into contacting engagement with the second sealing member.

14. The apparatus of claim 11, further comprising a port coupled to the manifold with a sealing cap, the port facilitating connection of a test device to measure an operational condition of the vapor space.

15. The apparatus of claim 11, wherein the first and second pressure equalization assemblies are each respectively adjustable to change the respective underpressure and overpressure differentials at which fluidic communication is established between the vapor space and the surrounding atmosphere.

16. The apparatus of claim 11, wherein said underpressure and overpressure differentials are each adjustably selected by:
closing a valve to temporarily isolate the vapor space from an interior of the manifold;
using a pressure/vacuum assembly to set a pressure of the interior of the manifold to a selected level;
adjusting a selected one of the underpressure or overpressure relief assemblies to open at said selected level; and
opening the valve to establish fluidic communication between the vapor space and the interior of the manifold.

17. The apparatus of claim 11, wherein the liquid storage vessel has a maximum specified underpressure differential between the pressure of the vapor space and the pressure of the surrounding atmosphere that the storage vessel can accommodate without damage being induced to the storage vessel, and wherein the first pressure equalization assembly is configured to establish fluidic communication between the vapor space and the surrounding environment when the underpressure differential reaches a selected derated percentage of said maximum specified underpressure differential.

18. The apparatus of claim 11, wherein the liquid storage vessel has a maximum specified overpressure differential between the pressure of the vapor space and the pressure of the surrounding atmosphere that the storage vessel can accommodate without damage being induced to the storage vessel, and wherein the second pressure equalization assembly is configured to establish fluidic communication between the vapor space and the surrounding environment when the overpressure differential reaches a selected derated percentage of said maximum specified overpressure differential.
